(19) United States
(12) Patent Application Publication
(10) Pub. No.: US 2017/0268594 A1
(43) Pub. Date: Sep. 21, 2017

(54) PRESSURE CUSHIONING DEVICE

(71) Applicant: Showa Corporation, Gyoda City (JP)

(72) Inventors: Nobuo MORI, Gyoda City (JP); Hiroshi ENDO, Gyoda City (JP); Yu KUROSAKI, Gyoda City (JP)

(73) Assignee: Showa Corporation, Gyoda City (JP)

(21) Appl. No.: 15/505,221

(22) PCT Filed: Sep. 19, 2014
(86) PCT No.: PCT/JP2014/074950

§ 371 Date: Feb. 20, 2017

(30) Foreign Application Priority Data
Aug. 26, 2014 (JP) 2014-171979

(51) Int. Cl. F16F 9/48; F16F 9/50; F16F 9/18

(52) U.S. Cl. CPC F16F 9/48; F16F 9/18; F16F 9/50; F16F 2222/12; F16F 2230/0052; F16F 2232/08; B60G 13/08

(57) ABSTRACT

A hydraulic pressure cushioning device includes: a cylinder; a rod movably provided in the cylinder; a first piston valve section that is provided on the rod. The first piston valve section includes: a first piston member and a second piston member that form a channel; and a single first damping valve with which a first flow of the fluid from the first side to the second side in the channel and a second flow of the fluid from the second side to the first side in the channel are controlled; a bypass path which differs from the channel; and a free piston provided on the rod in such a manner that a flow of the fluid is switched between the channel and the bypass path in accordance with a movement position of the rod.

### CROSS-REFERENCE TO RELATED PATENT APPLICATIONS

This application is a U.S. National Phase Application under 35 U.S.C. §371 of International Patent Application No. PCT/JP2014/074950, filed Sep. 19, 2014, and claims the benefit of Japanese Patent Application No. 2014-171979, filed Aug. 26, 2014, all of which are incorporated by reference in their entireties herein. The International Application was published in Japanese on March 3, 2016 as International Publication No. WO/2016/031087 under PCT Article 21(2).

### FIELD OF THE INVENTION

The present invention relates to a pressure cushioning device.

### BACKGROUND OF THE INVENTION

Suspension devices in automobiles and other vehicles are provided with a pressure cushioning device. The pressure cushioning device uses a damping force generator that appropriately reduces the vibration transmitted to a body of a travelling vehicle from a road surface. Japanese Patent No. 4945567 discloses an example of a pressure cushioning device of this type. More specifically, a disclosed vibration damper includes a cylinder with which a piston rod can be guided to move in an axial direction. A first piston is fixedly fastened to the piston rod. A second piston includes at least one valve disc that receives pretension from a spring assembly, and is supported to be movable in the axial direction against elastic force of at least one supporting spring. The spring assembly includes at least one spring plate, and is supported while applying force to the spring plate.

### SUMMARY OF THE INVENTION

### Problems to be Solved by the Invention

An object of the present invention is to downsize a pressure cushioning device in which generated damping force changes in accordance with a stroke amount of a rod.

### Means for Solving the Problems

The present invention that achieves the object described above is a pressure cushioning device including: a cylinder that is configured to store fluid; a rod configured to move in an axial direction of the cylinder and has an end on a first side accommodated in the cylinder and an end on a second side protruding from an opening of the cylinder; a piston valve that is provided to the rod and includes: a channel forming section that forms a channel for the fluid between the first side and the second side in the axial direction; and a single valve with which a first flow of the fluid from the second side to the first side in the channel and a second flow of the fluid from the first side to the second side in the channel are controlled; a bypass path that forms a channel for the fluid between the first side and the second side in the axial direction of the piston valve, the bypass path being different from the channel of the piston valve; and a free piston that is movably provided to the rod in such a manner that a flow of the fluid is switched between the channel and the bypass path in accordance with a movement position of the rod. The first flow and the second flow are controlled with the single valve, and thus the number of parts required can be reduced and the downsizing of the device can be achieved compared with a configuration in which, for example, the first flow and the second flow are controlled with different valves.

### Advantageous Effects of Invention

With the present invention, a pressure cushioning device in which generated damping force changes in accordance with a stroke amount of a rod can be downsized.

### BRIEF DESCRIPTION OF THE DRAWINGS

FIG. 1 is a diagram illustrating an overall configuration of a hydraulic pressure cushioning device according to an embodiment of the present invention.

FIG. 2 is a diagram illustrating the hydraulic pressure cushioning device according to the embodiment in detail.

FIG. 3 is an exploded perspective view of a first piston valve section and a free piston section according to the embodiment.

FIG. 4 is a diagram illustrating an overall configuration of a first piston member according to the embodiment.

FIGS. 5A and 5B are each a diagram illustrating how oil flows in the hydraulic pressure cushioning device during a compression stroke.

FIGS. 6A and 6B are each a diagram illustrating how oil flows in the hydraulic pressure cushioning device during an extension stroke.

FIGS. 7A and 7B are each a diagram illustrating how oil flows in the first piston valve section.

FIGS. 8A to 8C are each a diagram illustrating a first piston valve section according to a modification.

FIGS. 9A and 9B are each a diagram illustrating how the hydraulic pressure cushioning device according to the present embodiment is assembled.

### DETAILED DESCRIPTION OF THE INVENTION

An embodiment of the present invention is described in detail below with reference to the attached drawings.

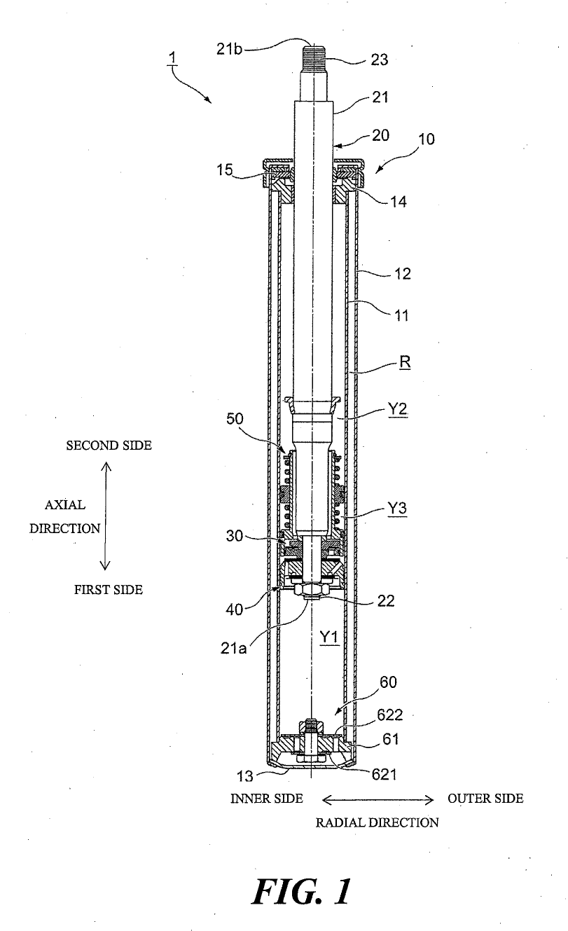

FIG. 1 is a diagram illustrating an overall configuration of a hydraulic pressure cushioning device 1 according to the present embodiment.

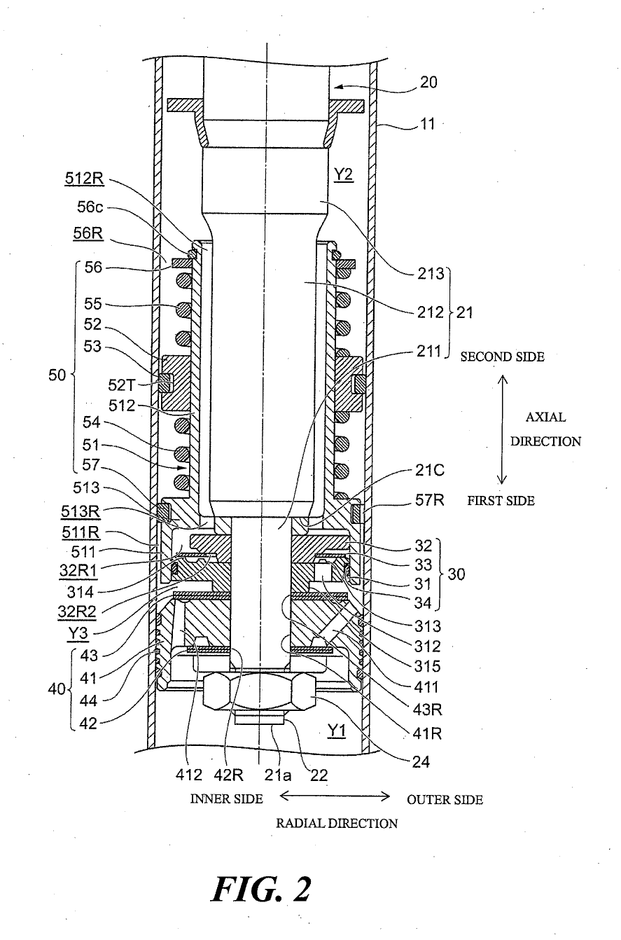

FIG. 2 is a diagram illustrating the hydraulic pressure cushioning device 1 according to the present embodiment in detail.

In the description below, a lower side and an upper side, in an axial direction of the hydraulic pressure cushioning device 1 illustrated in FIG. 1, in the figure are respectively referred to as a “first side” and a “second side”. A left and right direction of the hydraulic pressure cushioning device 1 illustrated in FIG. 1 is simply referred to as a “radial direction”. A side of a center axis is referred to as an “inner side”, and a side separated from the center axis in the radial direction is referred to as an “outer side”.

### [Configuration and Function of Hydraulic Pressure Cushioning Device 1]

As illustrated in FIG. 1, a hydraulic pressure cushioning device 1 (pressure cushioning device) includes a cylinder section 10, a rod section 20, a first piston valve section 30 (piston valve), a second piston valve section 40, a free piston section 50, and a bottom valve section 60. The rod section 20 has a first side slidably inserted in the cylinder section 10 and has a second side protruding out from the cylinder section 10. The first piston valve section 30 is provided on an end of the rod section 20 on the first side. The second piston valve section 40 is disposed more on the first side than the first piston valve section 30. The free piston section 50 is provided on the second side of the first piston valve section 30. The bottom valve section 60 is provided to an end of the cylinder section 10 on the first side.

The hydraulic pressure cushioning device 1 is disposed between a vehicle body and an axle of a four-wheel vehicle, a two-wheel vehicle, or the like, and reduces the amplitude of the movement of the rod section 20 relative to the cylinder section 10.

As illustrated in FIG. 1, the cylinder section 10 includes a cylinder 11, an outer cylinder member 12 provided on an outer side of the cylinder 11, and a bottom section 13 provided on an end on the first side in the axial direction. The cylinder section 10 further includes a rod guide 14 provided to an end of the cylinder 11 on the second side, and a sealing member 15 that closes the end of the outer cylinder member 12 on the second side.

In the present embodiment, the rod section 20 includes: a rod 21 formed to extend in the axial direction; a first side attachment section 21a provided to an end of the rod 21 on the first side; and a second side attachment section 21b provided to an end of the rod 21 on the second side.

As illustrated in FIG. 2, the first piston valve section 30 includes: a first piston member 31 (first member) provided on the first side; a second piston member 32 (second member) provided on the second side; a first damping valve 33 (valve) provided between the first piston member 31 and the second piston member 32; and a sealing member 34 provided on an outer circumference of the first piston member 31.

As illustrated in FIG. 2, the second piston valve section 40 includes: a second piston 41; a second extension side damping valve 42 provided on the first side of the second piston 41; a second compression side damping valve 43 provided on the second side of the second piston 41; and a piston ring 44 provided on an outer circumference of the second piston 41.

As illustrated in FIG. 2, the free piston section 50 includes: a piston casing 51; a free piston 52 provided on an outer side of the piston casing 51 in a radial direction; a sealing ring 53 disposed on the outer side of the free piston 52 in the radial direction; a first spring 54 provided on the first side of the free piston 52; a second spring 55 provided on the second side of the free piston 52; a stopper ring 56 provided on the second side of the second spring 55; and a second piston ring 57 provided on an outer circumference of the piston casing 51 on the first side.

As illustrated in FIG. 1, the bottom valve section 60 includes: a valve body 61 including a plurality of oil paths formed therethrough in the axial direction; a compression side valve 621 provided on the first side of the valve body 61; and an extension side valve 622 provided on the second side of the valve body 61.

In the hydraulic pressure cushioning device 1 according to the present embodiment, a first oil chamber Y1 is formed at a portion more on the first side in the axial direction than the piston ring 44 of the second piston valve section 40 as illustrated in FIG. 2. A second oil chamber Y2 is formed at a portion more on the second side in the axial direction than the free piston 52 and the sealing ring 53 of the free piston section 50. Furthermore, an intermediate oil chamber Y3 is provided between the piston ring 44 and the free piston 52 and the sealing ring 53. Furthermore, as illustrated in FIG. 1, the first oil chamber Y1 and a reservoir chamber R (see FIG. 1) are partitioned by the valve body 61 of the bottom valve section 60 in the hydraulic pressure cushioning device 1.

A schematic configuration of the hydraulic pressure cushioning device 1 according to the present embodiment is described below.

As illustrated in FIG. 1 and FIG. 2, the hydraulic pressure cushioning device 1 (pressure cushioning device) includes: the cylinder 11 that stores oil (fluid); the rod 21 that is movable in the axial direction in the cylinder 11 and has the end on the first side accommodated in the cylinder 11 and the end on the second side protruding from an opening of the cylinder 11; a first piston valve section 30 (piston valve) that is provided to the rod 21 and includes: the first piston member 31 and the second piston member 32 (channel forming sections) that form a channel for oil between the first side and the second side in the axial direction; and a single first damping valve 33 (valve) with which a first flow of oil from the first side to the second side in the channel and a second flow of the oil from the second side to the first side in the channel are controlled; a bypass path that forms a channel for the oil between the first side and the second side in the axial direction of the first piston valve section 30, the bypass path being different from the channel of the first piston valve section 30; and a free piston 52 movably provided to the rod 21 in such a manner that the flow of the oil is switched between the channel and the bypass path in accordance with a movement position of the rod 21.

A configuration of each of these components is described below.

### [Configuration and Function of Rod Section 20]

As illustrated in FIG. 2, the rod 21 is a rod-shaped member elongated in the axial direction. The rod 21 according to the present embodiment includes: a first column section 211 on the first side; a second column section 212 that is on the second side of the first column section 211 and has a larger outer diameter than the first column section 211; and a third column section 213 that is on the second side of the second column section 212 and has a larger outer diameter than the second column section 212.

As illustrated in FIG. 1 and FIG. 2, a bolt 22 is formed on the first side attachment section 21a of the rod 21. A nut 24 is attached to the bolt 22 and holds the first piston valve section 30, the second piston valve section 40, and the free piston section 50. Meanwhile, a bolt 23 is formed on the second side attachment section 21b of the rod 21 (see FIG. 1). A coupling member (not illustrated) is attached to the bolt 23 so that the hydraulic pressure cushioning device 1 is coupled to a vehicle body of an automobile and the like.

### [Configuration and Function of First Piston Valve Section 30]

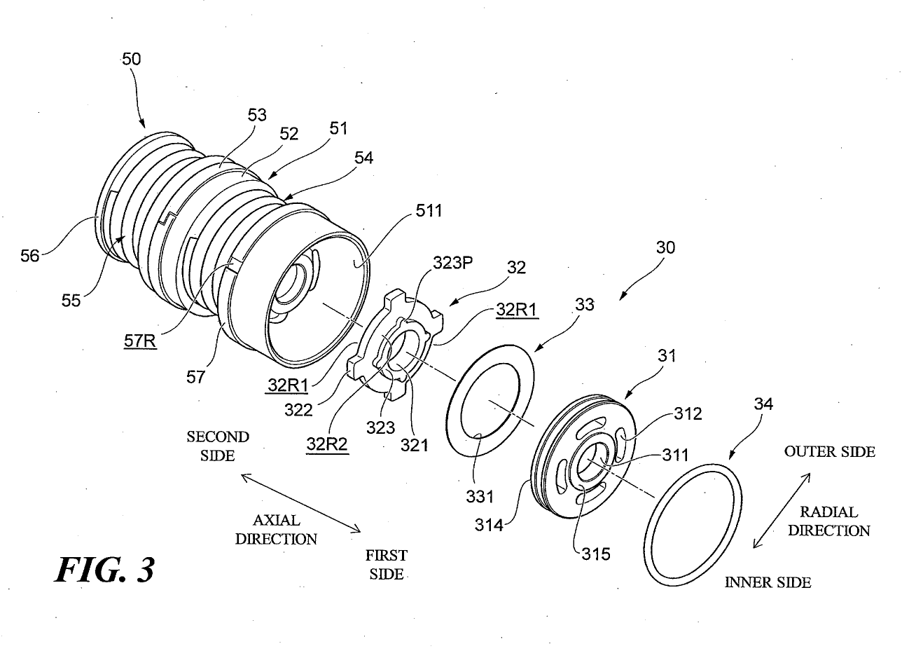

FIG. 3 is an exploded perspective view of the first piston valve section 30 and the free piston section 50 according to the present embodiment.

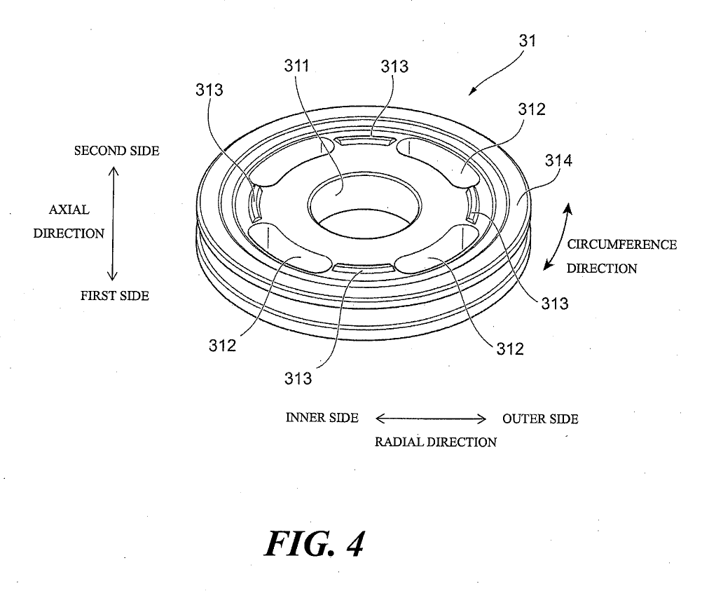

FIG. 4 is a diagram illustrating an overall configuration of the first piston member 31 according to the present embodiment.

(First piston member 31)

As illustrated in FIG. 4, the first piston member 31 is a substantially column member including a rod hole 311 through which the first column section 211 of the rod 21 is inserted. The first piston member 31 includes: a first oil path 312 formed through the first piston member 31 at a portion more on an outer side in the radial direction than the rod hole 311; a protrusion 313 formed on the second side of the first piston member 31; an annular protrusion 314 formed on the second side of the first piston member 31; and an inner annular protrusion 315 formed on the first side of the first piston member 31 (see FIG. 3).

As illustrated in FIG. 2, the first oil path 312 has the first side in the axial direction communicating with the first oil chamber Y1, and the second side facing the first damping valve 33. In the present embodiment, a plurality of (four) first oil paths 312 are formed as illustrated in FIG. 4.

As illustrated in FIG. 4, the protrusion 313 further protrudes in the axial direction toward the second side, from the second side of the first piston member 31. In the present embodiment, the protrusion 313 has a substantially arc shape, and is disposed between each two of the first oil paths 312 adjacent to each other in a circumference direction. The protrusion 313 has a protrusion height set to be high enough to be in contact with the first damping valve 33 during an extension stroke, to prevent the first damping valve 33 from closing the first oil paths 312. In the present embodiment, the protrusion 313 is formed to have the protrusion height smaller than that of the annular protrusion 314. As described below, the protrusion 313 is in contact with the first damping valve 33 in a state where damping force is generated by the first damping valve 33 and the first oil path 312 while the oil is flowing in the first damping valve 33 and the first oil path 312.

Thus, the first piston member 31 (channel forming section) includes the protrusions 313 that protrude from the first piston member 31 toward the first damping valve 33 (valve), and come in contact with the first damping valve 33 while the oil is flowing in the first oil paths 312 (channels).

The annular protrusion 314 has an annular form, is formed at an outer end of the first piston member 31 in the radial direction, and protrudes toward the second side. The annular protrusion 314 is formed to have the protrusion height in the axial direction that is larger than that of the protrusions 313. As illustrated in FIG. 2, the annular protrusion 314 comes into contact with an outer end of the first damping valve 33 in the radial direction.

As illustrated in FIG. 3, the inner annular protrusion 315 is formed around the rod hole 311, and protrudes in the axial direction towards the first side from the first side of the first piston member 31. As illustrated in FIG. 2, the inner annular protrusion 315 supports the inner side of the second compression side damping valve 43 of the second piston valve section 40 in the radial direction, whereby a space enabling deformation on an outer side in the radial direction is formed.

The first piston member 31 having the configuration described above is accommodated on the inner side of the piston casing 51 of the free piston section 50, with the sealing member 34 attached to the outer circumference of the first piston member 31.

### (Second Piston Member 32)

As illustrated in FIG. 3, the second piston member 32 has a substantially column schematic shape and includes a rod hole 321 through which the first column section 211 (see FIG. 2) of the rod 21 is inserted. The second piston member 32 has an outer circumference portion provided with a plurality of (four in the present embodiment) radial direction protruding sections 322 protruding outward in the radial direction. The second piston member 32 further has the first side provided with an axial direction protruding section 323.

The second piston member 32 has an outer diameter (at a portion without the radial direction protruding sections 322) that is smaller than an inner diameter of a second cylindrical section 512 of the piston casing 51. Thus, second channels 32R1 (channel (second channel)) where the oil flows are defined between the second piston member 32 and the second cylindrical section 512.

The plurality of radial direction protruding sections 322 are formed in such a manner that a virtual circle connecting between their outer ends in the radial direction has an outer diameter that is substantially the same as an inner diameter of the second cylindrical section 512 of the piston casing 51. Thus, the second piston member 32 is positioned with respect to the piston casing 51. In the present embodiment, the piston casing 51 has its center aligned with the center of the second piston member 32 in the axial direction (centering).

The axial direction protruding section 323 is formed around the rod hole 321, and has an annular form protruding toward the first side in the axial direction from the first side of the second piston member 32. The axial direction protruding section 323 has an outer circumference provided with a plurality of (four in the present embodiment) radial direction protruding sections 323P protruding outward in the radial direction.

The axial direction protruding section 323 has an outer diameter (at a portion without the radial direction protruding sections 323P) smaller than an inner diameter of an opening 331 of the first damping valve 33 described below. Thus, a channel 32R2 where the oil flows is defined between the axial direction protruding section 323 and the first damping valve 33.

The plurality of radial direction protruding sections 323P are formed in such a manner that a virtual circle connecting between their ends on the outer side in the radial direction has an outer diameter substantially the same as the inner diameter of the opening 331 described below. Thus, in the present embodiment, the first damping valve 33 is positioned. In the present embodiment, the first damping valve 33 has the center aligned with the center of the second piston member 32 in the axial direction (centering).

In the present embodiment, the plurality of radial direction protruding sections 323P are formed in such a manner that a virtual circle connecting between their ends in the outer side in the radial direction has an outer diameter smaller than the inner diameter of the annular protrusion 314 of the first piston member 31. The second piston member 32 has an outer diameter on the second side that is larger than the inner diameter of the annular protrusion 314 of the first piston member 31. Thus, the first piston member 31 (first member) has the annular protrusion 314 to have a “recess” formed on the second side. The second piston member 32 (second member) is formed to have an outer diameter on the first side smaller than the inner diameter of the “recess”, and to have an outer diameter on the second side larger than the inner diameter of the “recess”.

### (First Damping Valve 33)

As illustrated in FIG. 3, the first damping valve 33 is a disc-like member having the opening 331 on the inner side in the radial direction. The first damping valve 33 is clamped between the first piston member 31 and the second piston member 32 with the opening 331 fit on the axial direction protruding section 323 of the second piston member 32.

### (Sealing Member 34)

As illustrated in FIG. 2, the sealing member 34 is clamped between the outer circumference of the first piston member 31 and the inner circumference of a first cylindrical section 511 of the piston casing 51, and thus seals between the first piston member 31 and the first cylindrical section 511.

### [Configuration and Function of Second Piston Valve Section 40]

As illustrated in FIG. 2, the second piston 41 is a substantially column member having a rod hole 41R through which the first column section 211 of the rod 21 is inserted. The second piston 41 includes: a plurality of third oil paths 411 that are formed to extend in the axial direction at portions more on the outer side than the rod hole 41R in the radial direction; and a plurality of fourth oil paths 412 formed to extend in the axial direction at portions more on the outer side than the rod hole 41R in the radial direction.

The second extension side damping valve 42 is formed of a disc-like metal plate member having a rod hole 42R through which the first column section 211 of the rod 21 is inserted. The second extension side damping valve 42 is held while being pressed against the end of the second piston 41 on the first side. With the second extension side damping valve 42, the first side of the third oil path 411 of the second piston 41 can be opened and closed, and the first side of the fourth oil path 412 is constantly open.

The second compression side damping valve 43 is formed of a disc-like metal plate member having a rod hole 43R through which the first column section 211 of the rod 21 is inserted. The second compression side damping valve 43 is held while being pressed against the end of the second piston 41 on the second side. With the second extension side damping valve 43, the second side of the fourth oil path 412 of the second piston 41 can be opened and closed, and the second side of the third oil path 411 is constantly open.

The piston ring 44 has an outer diameter that is substantially the same as the inner diameter of the cylinder 11. The piston ring 44 achieves sealing with the cylinder 11. The piston ring 44 is in contact with the inner circumference of the cylinder 11 in such a manner as to be slidable in the axial direction.

### [Configuration and Function of Free Piston Section 50]

### (Piston Casing 51)

As illustrated in FIG. 2, the piston casing 51 includes: the first cylindrical section 511 formed on the first side; the second cylindrical section 512 formed on the second side; and a connection section 513 formed between the first cylindrical section 511 and the second cylindrical section 512.

A cylindrical space is formed on the inner side of the first cylindrical section 511, and accommodates the second side of the first piston valve section 30 in the present embodiment. The first cylindrical section 511 has an outer diameter that is smaller than the inner diameter of the cylinder 11. Thus, a casing outer channel 511R (bypass path) is formed between the first cylindrical section 511 and the cylinder 11, and serves as the oil path between the first side and the second side of the first piston valve section 30 in the axial direction.

A cylindrical space is formed on the inner side of the second cylindrical section 512, and accommodates the second column section 212 of the rod 21 in the present embodiment. The second cylindrical section 512 has an inner diameter larger than the outer diameter of the second column section 212. Thus, a casing inner channel 512R in which the oil flows is formed between the second cylindrical section 512 and the second column section 212.

The connection section 513 includes a rod hole through which the first column section 211 of the rod 21 is inserted. The connection section 513 is fixed to a step section 21C formed between the first column section 211 and the second column section 212 of the rod 21. The connection section 513 includes a connection section channel 513R provided more on the outer side than the rod hole in the radial direction. In the present embodiment, a plurality of the connection section channels 513R are provided along the circumference direction. The connection section channel 513R communicates between the inner side of the first cylindrical section 511 and the inner side of the second cylindrical section 512.

The piston casing 51 (containing member) is a single member that forms the casing outer channel 511R (bypass path), movably holds the free piston 52, and accommodates the first piston valve section 30 (piston valve).

### (Free Piston 52)

The free piston 52 is thick and has a substantially annular shape. The free piston 52 is formed to have an inner diameter that is substantially the same as the outer diameter of the second cylindrical section 512. The free piston 52 is attached to be slidable in the axial direction of the second cylindrical section 512, and thus is movable in the axial direction of the rod 21. The path of the oil is switched in accordance with a movement position of the free piston 52 relative to the rod 21 between: a path including the first oil path 312 (channel (first channel)) of the first piston valve section 30; and a path bypassing the first piston valve section 30 and including a stopper ring channel 56R, the casing outer channel 511R, and a piston ring channel 57R (bypass path). In the present embodiment, damping force generated by the first piston valve section 30 changes in accordance with the movement position of the free piston 52 relative to the rod 21.

In the present embodiment, the free piston 52 is pressed to the first side or the second side in the axial direction, by the first spring 54 disposed on the first side and the second spring 55 on the second side, in accordance with the position in the axial direction.

### (Sealing Ring 53)

The sealing ring 53 fits in an annular groove 52T formed on the outer side of the free piston 52 in the radial direction. The sealing ring 53 is formed to have an outer diameter that is substantially the same as the inner diameter of the cylinder 11. The sealing ring 53 is provided to be slidable in the axial direction with respect to the cylinder 11. The sealing ring 53 seals between the free piston 52 and the cylinder 11.

### (First Spring 54)

The first spring 54 (urging member) has the first side attached to the connection section 513 of the piston casing 51 and the second side attached to the free piston 52. The first spring 54 urges the free piston 52 in the axial direction. More specifically, the first spring 54 applies force to the free piston 52 so that the free piston 52 is pressed toward the second side and pulled toward the first side, in accordance with position of the free position 52 in the axial direction. The first spring 54 uses elastic force to apply force against the movement of the free piston 52, to the free piston 52.

### (Second Spring 55)

The second spring 55 (urging member) has the second side attached to the stopper ring 56 and has the first side attached to the free piston 52. The second spring 55 urges the free piston 52 in the axial direction. More specifically, the second spring 55 applies force to the free piston 52 so that the free piston 52 is pressed toward the first side and pulled toward the second side, in accordance with position of the free position 52 in the axial direction. The second spring 55 uses elastic force to apply force against the movement of the free piston 52, to the free piston 52.

### (Stopper Ring 56)

The stopper ring 56 is formed to have an outer diameter smaller than the inner diameter of the cylinder 11. Thus, the stopper ring channel 56R is formed between the stopper ring 56 and the cylinder 11. The stopper ring 56 is formed to have an inner diameter that is the same as the outer diameter of the second cylindrical section 512. The stopper ring 56 is fixed by a fixing jig 56c fixed to a groove on the second side of the second cylindrical section 512, so as not to move toward the second side. In the present embodiment, the stopper ring 56 holds the second side end of the second spring 55.

### (Second Piston Ring 57)

The second piston ring 57 is formed to have an outer diameter that is substantially the same as the inner diameter of the cylinder 11. The second piston ring 57 achieves sealing with the cylinder 11. The second piston ring 57 includes the piston ring channel 57R formed therethrough from the first side to the second side in the axial direction. With the piston ring channel 57R, the oil can flow between the first side and the second side of the second piston ring 57.

In the present embodiment, as illustrated in FIG. 2, the first spring 54, the free piston 52, and the second spring 55 are inserted in this order from the second side in the second cylindrical section 512 of the piston casing 51, to be arranged in series. Assembling for the first spring 54, the free piston 52, and the second spring 55 can be completed simply by fixing the stopper ring 56 with the fixing jig 56c on the second side of the second spring 55. Thus, the assembling in the free piston section 50 is easily achieved.

The hydraulic pressure cushioning device 1 according to the present embodiment switches the magnitude of the damping force in accordance with a stroke amount (for example, small stroke 51 and large stroke S2) of the rod 21. In the present embodiment, the small stroke 51 corresponds to a stroke amount with which the oil passes through the channel (the third oil path 411 or the fourth oil path 412) in the second piston valve section 40 instead of the channel (the first oil path 312) in the first piston valve section 30, and the hydraulic pressure cushioning device 1 provides relatively small damping force. The large stroke S2 corresponds to a stroke amount with which the oil passes through the channel in the second piston valve section 40 and the channel in the first piston valve section 30, and the hydraulic pressure cushioning device 1 provides relatively large damping force.

More specifically, as described below for example, stroke amounts of the rod 21 causing the free piston 52 to abut with the first side or the second side and smaller correspond to the small stroke S, and stroke amounts greater than the stroke amount of the rod 21 causing the abutting correspond to the large stroke S2.

### [Operation of Hydraulic Pressure Cushioning Device 1]

Next, an operation of the hydraulic pressure cushioning device 1 with the configuration described above is described.

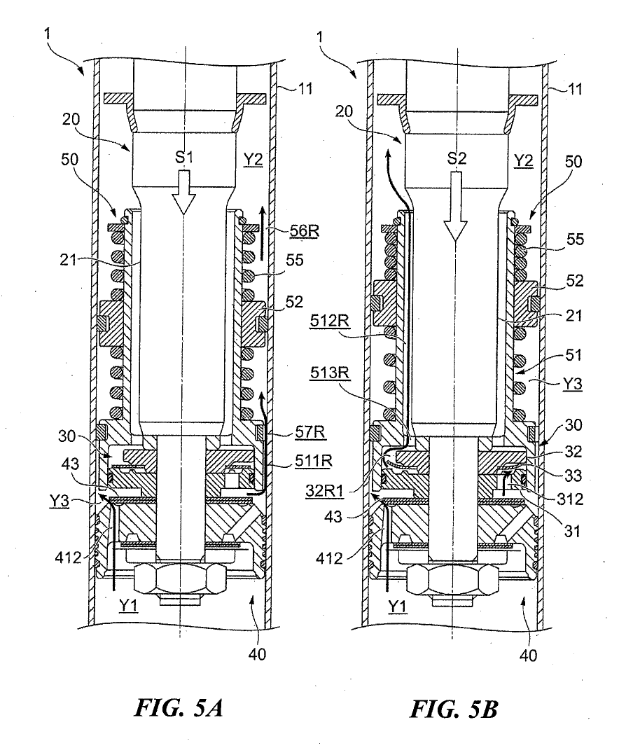

FIGS. 5A and 5B are diagrams illustrating how the oil flows during the compression stroke in the hydraulic pressure cushioning device 1. FIG. 5A illustrates how the oil flows when the rod 21 moves over the small stroke S1. FIG. 5B illustrates how the oil flows when the rod 21 moves over the large stroke S2.

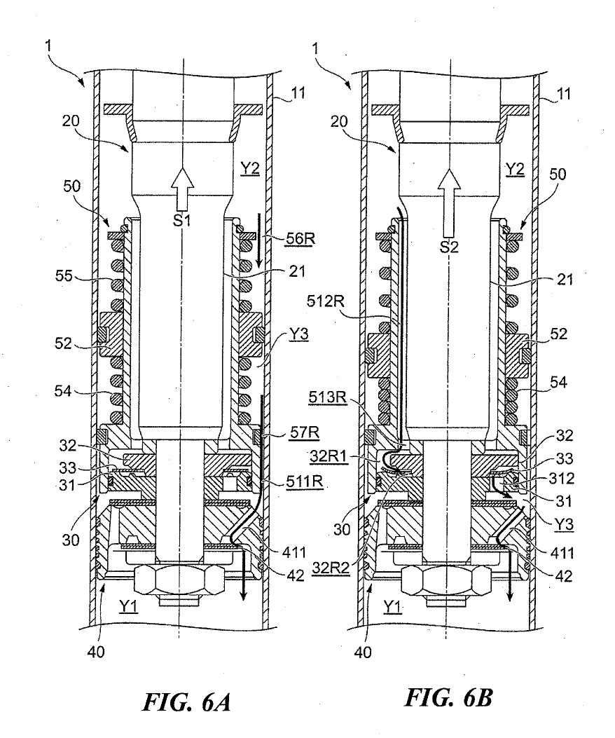

FIGS. 6A and 6B are diagrams illustrating how the oil flows during an extension stroke in the hydraulic pressure cushioning device 1. FIG. 6A illustrates how the oil flows when the rod 21 moves over the small stroke S1. FIG. 6B illustrates how the oil flows when the rod 21 moves over the large stroke S2.

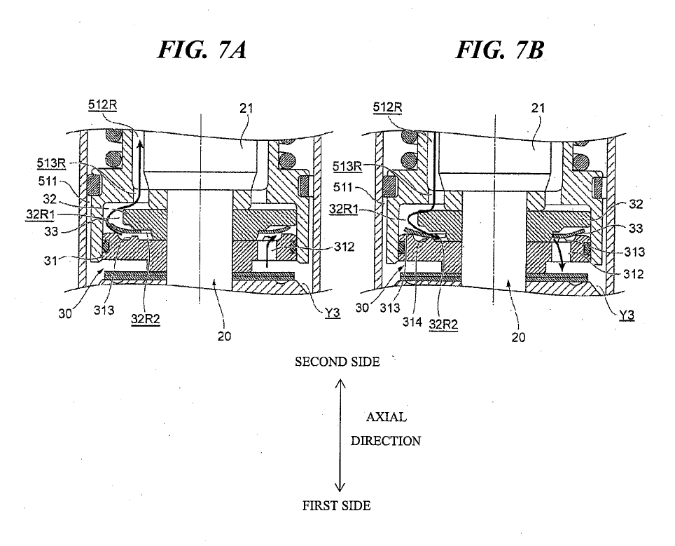

FIGS. 7A and 7B illustrate how the oil flows in the first piston valve section 30. FIG. 7A illustrates how the oil flows in the compression stroke involving the movement of the rod 21 in the large stroke S2, and FIG. 7B illustrates how the oil flows in the extension stroke involving the movement of the rod 21 in the large stroke S2.

### (During Compression Stroke (Small Stroke S1))

First of all, an operation of the hydraulic pressure cushioning device 1 during the compression stroke is described with reference to FIGS. 5A and 5B. In this described case, the rod 21 moves over the small stroke S1.

The rod 21 moves toward the first side in the axial direction as indicated by a white arrow in FIG. 5A. The movement toward the first side of the second piston valve section 40 causes a pressure rise in the first oil chamber Y1. The intermediate chamber Y3 has lower pressure than the first oil chamber Y1. The pressure difference between the first oil chamber Y1 and the intermediate oil chamber Y3 opens the second compression side damping valve 43 closing the fourth oil path 412. Thus, the oil flows into the intermedia oil chamber Y3 through the fourth oil path 412. The flow of oil from the first oil chamber Y1 to the intermediate oil chamber Y3 is narrowed by the second compression side damping valve 43 and the fourth oil path 412, and acts as the damping force during the compression stroke in the hydraulic pressure cushioning device 1.

The oil flowing into the intermediate oil chamber Y3 from the first oil chamber Y1 causes a pressure rise in the intermediate oil chamber Y3. However, the pressure rise in the intermediate oil chamber Y3 due to the oil flowing in is offset due to the movement of the free piston 52 toward the second side. More specifically, the oil flows in the casing outer channel 511R and the piston ring channel 57R to flow into the first side of the free piston 52. In this process, the free piston 52 moves toward the second side. On the second side of the free piston 52, the oil flows toward the second side in the stopper ring channel 56R (on the second side of the free piston 52). The pressure in the intermediate oil chamber Y3 is unlikely to rise when the free piston 52 is moving toward the second side. All things considered, the oil is less likely to flow through the first piston valve section 30, and thus the first piston valve section 30 generates substantially no damping force.

In the bottom valve section 60, the pressure rises in the first oil chamber Y1 as the rod 21 moves as illustrated in FIG. 1. Thus, the compression side valve 621 closing the oil path in the bottom valve section 60 opens. The oil in the first oil chamber Y1 flows into the reservoir chamber R. The flow of the oil from the first oil chamber Y1 to the reservoir chamber R is narrowed by the compression side valve 621 and the oil path in the valve body 61. As a result, the damping force is generated in the bottom valve section 60.

As described above, when the rod 21 moves over the small stroke S1 during the compression stroke, the damping force is mainly generated in the second piston valve section 40 and in the bottom valve section 60.

### (During Compression Stroke (Large Stroke S2))

Next, a case where the rod 21 moves over the large stroke S2 is described.

When the rod 21 moves over the large stroke S2, as illustrated in FIG. 5B, the oil gushes into the intermediate oil chamber Y3 through the second piston valve section 40. The free piston 52 moves toward the second side with the first spring 54 extended and the second spring 55 compressed. Then, in the present embodiment, the second spring 55 reaches a solid length, and the abutting of the free piston 52 occurs. Thus, unlike during the compression stroke (small stroke S 1) described above, no oil flows in the casing outer channel 511R or the piston ring channel 57R.

As a result, the oil pressure rises in the intermediate oil chamber Y3. On the other hand, the pressure in the second oil chamber Y2 drops due to the movement of the second piston valve section 40 toward the first side. The pressure difference between the intermediate oil chamber Y3 and the second oil chamber Y2 causes deformation of the first damping valve 33 closing the first oil path 312 in the first piston valve section 30.

More specifically, as illustrated in FIG. 7A, the first damping valve 33 has the outer side deformed toward the second side to be separated from the first piston member 31, with the inner side pressed against the first side end of the second piston member 32. Thus, the first piston member 31 is in a state where the first oil path 312 is open. The first damping valve 33 is in the state of being separated from the first piston member 31. Thus, the oil that has flowed through the first oil path 312 further flows between the first piston member 31 and the first damping valve 33. The oil further flows in the second channel 32R1.

Then, as illustrated in FIG. 5B, the oil flows in the first oil path 312 of the first piston member 31 to flow into the intermediate oil chamber Y3. How the oil flows thereafter is the same as that in the case where the oil flows in the second piston valve section 40 with the small stroke S1.

As described above, with the free piston 52, the flow of the oil in the casing outer channel 511R and the piston ring channel 57R (bypass path) with the small stroke S1 switches to the channel for flowing in the first oil path 312 of the first piston valve section 30 when the large stroke S2 is started. Then, the oil flows into the second oil chamber Y2. The flow of the oil from the intermediate oil chamber Y3 to the second oil chamber Y2 is narrowed by the first damping valve 33 and the first oil path 312, and acts as the damping force during the compression stroke in the hydraulic pressure cushioning device 1.

As described above, when the rod 21 moves over the large stroke S2 during the compression stroke, the damping force is generated in the second piston valve section 40 and the bottom valve section 60, and also on the first piston valve section 30 arranged in series with the second piston valve section 40. Thus, when the rod 21 moves over the large stroke S2, larger damping force is generated compared with the case of the movement in the small stroke S1.

### (During Extension Stroke (Small Stroke S1))

Next, an operation of the hydraulic pressure cushioning device 1 during the extension stroke is described with reference to FIGS. 6A and 6B. Furthermore, a case where the rod 21 moves over the small stroke S1 is described.

The rod 21 moves toward the second side in the axial direction relative to the cylinder 11 as indicated by a white arrow in FIG. 6A. The movement of the second piston valve section 40 toward the second side causes the pressure rise in the second oil chamber Y2. However, the pressure rise is offset by the movement of the free piston 52 toward the first side increasing the volume in the second oil chamber Y2. Thus, the pressure in the second oil chamber Y2 is less likely to be high in a state where the free piston 52 is moving. Thus, in this state, the oil is less likely to flow through the first piston valve section 30, and thus, a state where the first piston valve section 30 generates substantially no damping force is achieved.

When the free piston 52 moves toward the first side, the oil flows in the piston ring channel 57R and the casing outer channel 511R. The pressure rises in the intermediate oil chamber Y3 and drops in the first oil chamber Y1. The resultant pressure difference between the intermediate oil chamber Y3 and the first oil chamber Y1 opens the second extension side damping valve 42 closing the third oil path 411. The oil further passes through the third oil path 411 to flow into the first oil chamber Y1. The flow of the oil from the intermediate oil chamber Y3 to the first oil chamber Y1 is narrowed by the second extension side damping valve 42 and the third oil path 411, and acts as the damping force during the extension stroke in the hydraulic pressure cushioning device 1.

In the bottom valve section 60, the pressure in the first oil chamber Y1 drops as the rod 21 moves as illustrated in FIG. 1. Then, the extension side valve 622 closing the oil path of the bottom valve section 60 opens. The oil in the reservoir chamber R flows into the first oil chamber Y1. The flow of oil from the reservoir chamber R to the first oil chamber Y1 is narrowed by the extension side valve 622 and the oil path in the valve body 61. As a result, the damping force is generated in the bottom valve section 60.

As described above, when the rod 21 moves over the small stroke S1 during the extension stroke, the damping force is generated mainly in the second piston valve section 40 and the bottom valve section 60.

### (During Extension Stroke (Large Stroke S2))

Next, a case where the rod 21 moves over the large stroke S2 is described.

When the rod 21 moves over the large stroke S2, as illustrated in FIG. 6B, the free piston 52 moves toward the first side with the second spring 55 extended and the first spring 54 compressed. Then, in the present embodiment, the first spring 54 reaches the solid length, and the abutting of the free piston 52 occurs. Thus, unlike during the compression stroke (small stroke S1) described above, no oil flows in the casing outer channel 511R nor the piston ring channel 57R.

As a result, the pressure rises in the second oil chamber Y2. On the other hand, the movement of the second piston valve section 40 toward the second side causes a pressure drop in the first oil chamber Y1 which in turn causes a pressure drop in the intermediate oil chamber Y3. The oil in the second oil chamber Y2 flows in the casing inner channel 512R and the connection section channel 513R. The pressure difference between the second oil chamber Y2 and the intermediate oil chamber Y3 causes the deformation of the first damping valve 33 closing the first oil path 312 of the first piston valve section 30.

More specifically, as illustrated in FIG. 7B, the first damping valve 33 has the inner side deformed toward the first side to be separated from the second piston member 32, with the outer side pressed against the annular protrusion 314 of the second piston member 32. Thus, the first damping valve 33 is in a state of being separated from the second piston member 32. Thus, the oil that has flowed in the connection section channel 513R flows in the second channel 32R1. The oil further flows in the channel 32R2 while circumventing the inner side of the first damping valve 33. Then, the oil flows in the first oil path 312 of the first piston member 31 to flow into the intermediate oil chamber Y3.

In the present embodiment, the protrusions 313 (see FIG. 4) are provided on the second side of the first piston member 31. As illustrated in FIG. 7B, the protrusions 313 prevent the first oil path 312 from being closed by the first damping valve 33 even when the first damping valve 33 is deformed to be bent toward the first piston member 31. Thus, in the present embodiment, a stable flow of oil between the first damping valve 33 and the first oil path 312 can be achieved.

The flow of oil thereafter is the same as that in the second piston valve section with the small stroke S1.

As described above, with the free piston 52, the flow of the oil in the stopper ring channel 56R, the piston ring channel 57R, and the casing outer channel 511R (bypass path) with the small stroke S1 switches to the channel for flowing in the first oil path 312 of the first piston valve section 30 when the large stroke S2 is started. Then, the oil flows through the casing inner channel 512R, the connection section channel 513R, the first oil path 312, and the third oil path 411, to flow into the first oil chamber Y1. The flow of the oil from the second oil chamber Y2 to the first oil chamber Y1 is narrowed by the first damping valve 33 and the first oil path 312, and acts as the damping force during the extension stroke in the hydraulic pressure cushioning device 1.

As described above, when the rod 21 moves over the large stroke S2 during the extension stroke, the damping force is generated in the second piston valve section 40, the bottom valve section 60, and also in the first piston valve section 30. Thus, when the rod 21 moves over the large stroke S2, larger damping force is generated compared with the case where the rod 21 moves over the small stroke S1.

In the hydraulic pressure cushioning device 1 according to the present embodiment, the single first damping valve 33 in the first piston valve section 30 acts to generate the damping force during both the compression stroke and the extension stroke. Thus, for example, a smaller length in the axial direction and the like can be achieved, compared with a configuration including a plurality of “damping valves” separately acting during the compression stroke and during the extension stroke. All things considered, the downsizing of the device can be achieved with the hydraulic pressure cushioning device 1 according to the present embodiment.

### <Modification>

Next, a first piston valve section 30 according to a modification is described.

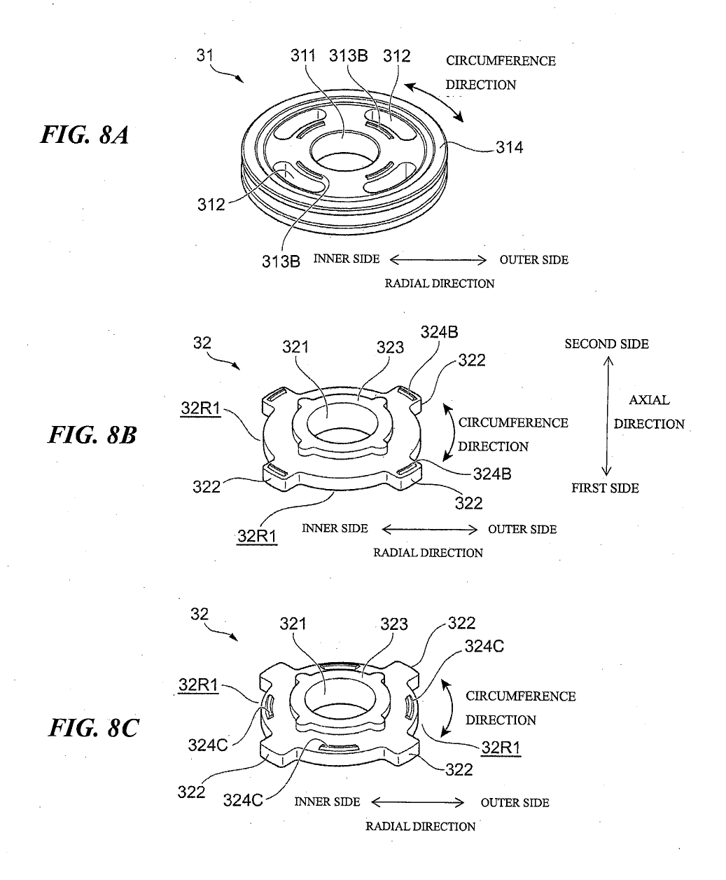

FIGS. 8A to 8C are diagrams illustrating the first piston valve section 30 according to the modification.

In the embodiment described above, the first piston member 31 is provided with the protrusions 313. The protrusions 313 come into contact with the first damping valve 33 to prevent the first oil path 312 from being closed by the first damping valve 33, while the oil is flowing during the extension stroke. A similar “protrusion” may be formed on the second piston member 32.

The modification described below features the arrangement of the “protrusion” in the first piston valve section 30. Components that are the same as the counterparts in the embodiment described above are denoted with the same reference numerals, and will not be described in detail.

As illustrated in FIG. 8A, protrusions 313B may be provided between the rod hole 311 and the first oil paths 312 in the radial direction, in the first piston member 31. In this configuration, the protrusions 313B come into contact with the first damping valve 33 to prevent the first oil path 312 from being closed by the first damping valve 33 while the oil is flowing in the first oil path 312 during the extension stroke (see FIG. 7B).

The second piston member 32 may also be provided with the “protrusion”.

As illustrated in FIG. 8B, protrusions 324B may be provided on the second side end surfaces of the radial direction protruding sections 322 in the second piston member 32. More specifically, the protrusions 324B are each disposed between each two of the second channels 32R1 adjacent to each other in the circumference direction. In this configuration, the protrusions 324B come into contact with the first damping valve 33 to prevent the second channels 32R1 from being closed by the first damping valve 33 while the oil is flowing in the second channels 32R1 during the compression stroke (see FIG. 7A).

Furthermore, as illustrated in FIG. 8C, protrusions 324C may be each provided between the rod hole 321 and the second channel 32R1 in the radial direction on the second side end surface of the second piston member 32. More specifically, the protrusions 324C are provided more on the inner side than the second channel 32R1 in the radial direction. Thus, the protrusions 324C come into contact with the first damping valve 33 to prevent the second channels 32R1 from being closed by the first damping valve 33 while the oil is flowing in the second channels 32R1 during the compression stroke (see FIG. 7A).

As described above, in the first piston valve section 30 according to the modification, the first piston member 31 (first member) includes the protrusion 313 or the protrusion 313B (first protrusion) that protrudes from the first piston member 31 toward the first damping valve 33 (valve) and comes into contact with the first damping valve 33 when the first flow from the second side to the first side during the extension stroke occurs in the first oil path 312 (first channel). The second piston member 32 (second member) includes the protrusion 324B or the protrusion 324C (second protrusion) that protrudes from the second piston member 32 toward the first damping valve 33, and comes into contact with the first damping valve 33 when the second flow from the first side to the second side during the compression stroke occurs in the second channel 32R1 (second channel).

### [Assembling of Hydraulic Pressure Cushioning Device 1]

Next, how the hydraulic pressure cushioning device 1 according to the present embodiment is assembled is described.

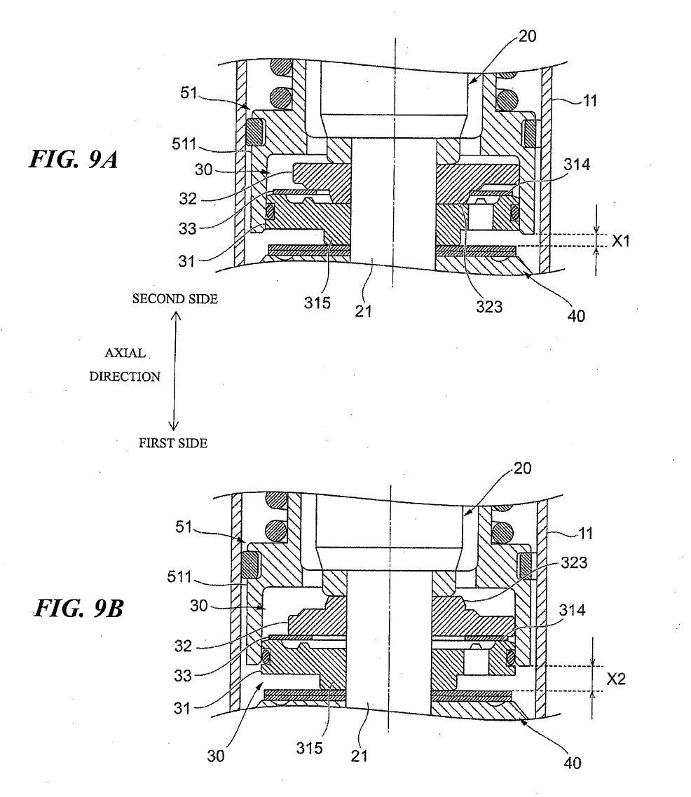

FIGS. 9A and 9B are diagrams illustrating how the hydraulic pressure cushioning device 1 according to the present embodiment is assembled.

Here, how the first piston valve section 30, the second piston valve section 40, and the free piston section 50 are assembled is described.

First of all, the piston casing 51 on which the first spring 54, the second spring 55, and the free piston 52 are attached is attached to the rod 21 (see FIG. 2). Then, the second piston member 32, the first damping valve 33, and the first piston member 31, as the components of the first piston valve section 30, are inserted in this order on the inner side of the first cylindrical section 511 on the first side of the piston casing 51 as illustrated in FIG. 9A. Then, as illustrated in FIG. 2, the second piston valve section 40 is assembled to the first side of the first piston valve section 30, and the bolt 22 is fixed. Thus, the first piston valve section 30, the second piston valve section 40, and the free piston section 50 can be assembled to the rod 21.

As described above, in the present embodiment, the various components of the free piston section 50 can be assembled on the second side of the piston casing 51, and the various components of the first piston valve section 30 can be assembled on the first side of the piston casing 51. Thus, for example, the assembly work for the first piston valve section 30 can be performed without a process of compressing the first spring 54 and the second spring 55 and the like performed during the assembling work. Thus, the assembling work can be prevented from being complicated, and thus can be easily performed.

Furthermore, the casing inner channel 512R can be formed between the rod 21 and the piston casing assembled to the rod 21. As described above, in the present embodiment, integrated forming of the channel and portions for attaching other functional sections can be achieved with the piston casing 51 alone. Thus, the assembling work can be performed extremely easily.

Furthermore, as illustrated in FIG. 9B, for example, the second piston member 32 may be upside down in the axial direction. Particularly, the second piston member 32 is provided further in the first cylindrical section 511 than the first piston member 31, and thus is hidden by the first piston member 31 when the first piston member 31 is attached. Thus, the assembled direction of the second piston member 32 cannot be checked from the outside.

In view of this, the second piston member 32 according to the present embodiment includes the axial direction protruding section 323 formed to be smaller than the inner diameter of the annular protrusion 314 of the first piston member 31. The axial direction protruding section 323 properly attached fits on the inner side of the annular protrusion 314 of the first piston member 31 as illustrated in FIG. 9A.

The axial direction protruding section 323 attached in the wrong orientation in the axial direction comes into contact with the piston casing 51 on the second side, and the second piston member 32 has the end placed on the annular protrusion 314 and the annular protrusion 314 of the first piston member 31 on the first side, as illustrated in FIG. 9B.

As a result, in the state where the first piston valve section 30 is attached, for example, the protruding length of the first piston valve section 30 on the first side end of the piston casing 51 differs between a protruding length X1 in a state with the proper attachment and a protruding length X2 in a state with the erroneous attachment. Thus, an operator can recognize the assembly error of the second piston member 32 by measuring the protruding length for example.

Similarly, the attachment error can be realized with the protruding length also when the second piston valve section 40 is further attached after the first piston valve section 30 is attached. Furthermore, the protruding length can be further used to realize any missing components in the first piston valve section 30, because the first piston member 31, the first damping valve 33, and the second piston member 32 are stacked in the axial direction.

The hydraulic pressure cushioning device 1 according to the present embodiment includes the first piston valve section 30, the second piston valve section 40, and the bottom valve section 60, and control of switching between the state where the damping force is generated and the state where the damping force is not generated is performed with the free piston section 50 in the first piston valve section 30. It is to be noted that the configurations of the second piston valve section 40 and the bottom valve section 60 among the components are not essential features, and the arranged position of the first piston valve section 30 is not limited to the present embodiment.

For example, the damping force can be changed in accordance with the stroke amount in the rod 21, even in a configuration including only the first piston valve section 30 and the free piston section 50. In this case, for example, in the state where the free piston 52 of the free piston section 50 according to the present embodiment is moving, a state where the damping force is less likely to be generated or low in the first piston valve section 30 is achieved. The damping force may be generated in the first piston valve section 30 in a state without the movement of the free piston 52.

### REFERENCE SIGNS LIST

1 . . . hydraulic pressure cushioning device
10 . . . cylinder section
11 . . . cylinder
21 . . . rod
30 . . . first piston valve section
31 . . . first piston member
32 . . . second piston member
33 . . . first damping valve
40 . . . second piston valve section
50 . . . free piston section
60 . . . bottom valve
Y1 . . . first oil chamber
Y2 . . . second oil chamber
Y3 . . . intermediate oil chamber

1. A pressure cushioning device, comprising:
a cylinder configured to store fluid;
a rod configured to move in an axial direction of the cylinder and has an end on a first side accommodated in the cylinder and an end on a second side protruding from an opening of the cylinder;
a piston valve that is provided to the rod and includes:
a channel forming section that forms a channel for the fluid between the first side and the second side in the axial direction; and
a single valve with which a first flow of the fluid from the second side to the first side in the channel and a second flow of the fluid from the first side to the second side in the channel are controlled;
a bypass path that forms a channel for the fluid between the first side and the second side in the axial direction of the piston valve, the bypass path being different from the channel of the piston valve; and
a free piston that is movably provided to the rod in such a manner that a flow of the fluid is switched between the channel and the bypass path in accordance with a movement position of the rod.

2. The pressure cushioning device of claim 1,
wherein the channel forming section includes a protrusion that protrudes from the channel forming section toward the valve and comes into contact with the valve while the fluid is flowing in the channel.

3. The pressure cushioning device of claim 1,
wherein the channel forming section includes:
a first member that includes a first channel forming the channel and is disposed on the first side of the valve; and
a second member that includes a second channel forming the channel and is disposed on the second side of the valve.

4. The pressure cushioning device of claim 3,
wherein the first member includes a first protrusion that protrudes from the first member toward the valve, and comes into contact with the valve when the first flow occurs in the first channel, and
wherein the second member includes a second protrusion that protrudes from the second member toward the valve, and comes into contact with the valve when the second flow occurs in the second channel.

5. The pressure cushioning device of claim 3,
wherein the first member includes a recess on the second side, and
wherein the second member is formed to have an outer diameter on the first side smaller than an inner diameter of the recess, and to have an outer diameter on the second side larger than the inner diameter of the recess.

6. The pressure cushioning device of claim 1, further comprising:
a containing member that is a single member that forms the bypass path, movably holds the free piston, and accommodates the piston valve.

7. The pressure cushioning device of claim 1, further comprising:
an urging member that urges the free piston in the axial direction.
